(19) United States
(12) Patent Application Publication
(10) Pub. No.: US 2025/0069087 A1
(43) Pub. Date: Feb. 27, 2025

(54) MERCHANDISE RETURN SUPPORT SYSTEM AND MERCHANDISE RETURN SUPPORT METHOD

(71) Applicant: Toshiba Tec Kabushiki Kaisha, Tokyo (JP)

(72) Inventor: Kentaro OKAMOTO, Mishima Shizuoka (JP)

(21) Appl. No.: 18/811,617

(22) Filed: Aug. 21, 2024

(30) Foreign Application Priority Data
Aug. 23, 2023 (JP) 2023-135528

(51) Int. Cl. G06Q 30/016; G06T 7/00

(52) U.S. Cl. CPC G06Q 30/016; G06T 7/0002

(57) ABSTRACT

According to one embodiment, a merchandise return support system includes a return support server. The return support server of the system acquires image data for a merchandise item that a user is attempting to return, identifies a state of the merchandise item based on the image data, then determines a response regarding the attempt to return the merchandise item based on the identified state of the merchandise item. The return server further outputs a notification to a terminal of the user indicating the response regarding the attempt to return the merchandise item.

### CROSS-REFERENCE TO RELATED APPLICATION

This application is based upon and claims the benefit of priority from Japanese Patent Application No. 2023-135528, filed Aug. 23, 2023, the entire contents of which are incorporated herein by reference.

### FIELD

Embodiments described herein relate generally to a merchandise return support system and a merchandise return support method.

### BACKGROUND

There are brick-and-mortar stores and EC (electronic commerce) sites that accept the return of a merchandise item previously purchased by a customer.

On the customer side, there is generally a desire to achieve a merchandise return in as simple a process as possible, often preferably without visiting a brick-and-mortar store or location. On the store side, there is a desire to provide the merchandise return service in as simple a process as possible because the store does not want to take unnecessary time to cope with handling the return.

### BRIEF DESCRIPTION OF THE DRAWINGS

FIG. 1 is a block diagram schematically showing an example of the configuration of a merchandise return support system according to an embodiment.

FIG. 2 is a block diagram schematically showing an example of the configuration of a server.

FIG. 3 is a block diagram schematically showing an example of the configuration of a user terminal.

FIG. 4 is a block diagram schematically showing an example of the configuration of a store terminal.

FIG. 5 is a sequence chart illustrating processing in a merchandise return support system.

FIG. 6 is a flowchart showing an example of second determination processing by a processing circuit of a server.

FIG. 7 is a flowchart illustrating an example of promotion determination processing by a processing circuit of a server.

### DETAILED DESCRIPTION

An embodiment described herein is to provide a technological solutions and improvements for systems supporting an online or in-store merchandise return procedure.

In general, according to one embodiment, a merchandise return support system includes a return support server. The return support server is configured to: acquire image data for a merchandise item that a user is attempting to return; identify a state of the merchandise item based on the image data; determine a response regarding the attempt to return the merchandise item based on the identified state of the merchandise item; and output a notification to a terminal of the user indicating the response regarding the attempt to return the merchandise item.

An example embodiment will now be described using the drawings. In the drawings, the scale, the dimensions, and the like of each element may be changed for purposes of explanation. In the drawings, some elements or aspects may be omitted for the sake of descriptive simplicity.

### Embodiment

### Example of Configuration

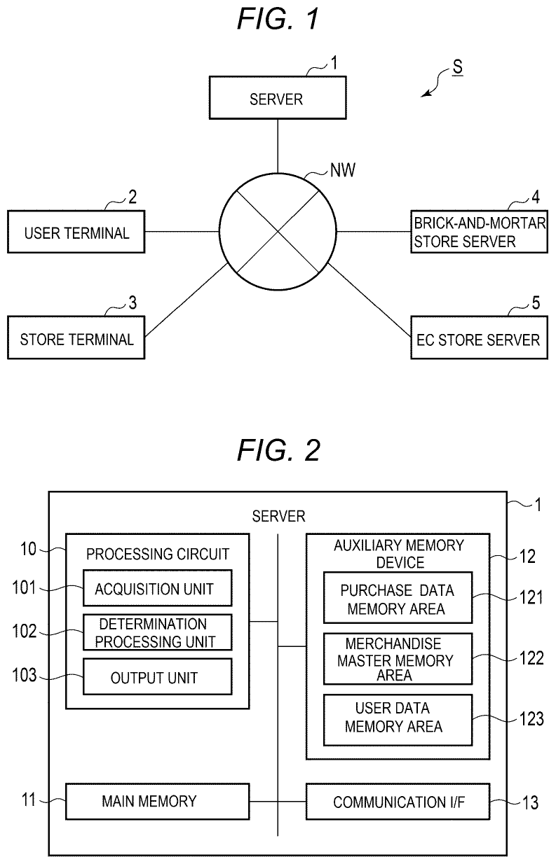

FIG. 1 is a block diagram schematically showing an example of the configuration of a merchandise return support system S.

The merchandise return support system S is provided for supporting an online merchandise return procedure.

A merchandise return is a process by which a customer returns a merchandise item after purchase with a refund being provided to the customer or an exchange of the merchandise item for another. In the description below, the merchandise item which the customer intends to return is referred to as a return target merchandise item and a transaction includes a payment to a store for a purchase of a merchandise item. From the store's point of view, the meaning of “transaction” is the sale of the merchandise item. From the customer's point of view, the meaning of “transaction” is the purchase of the merchandise item. The successful conclusion of the transaction includes the completion of a settlement process (payment process). The settlement is the payment of the cost of the items in the transaction. For example, the merchandise item in the transaction may be a tangible object. The store may be a brick-and-mortar store or may be an EC (electronic commerce) store or the like.

A refund is a return of the full or partial amount of the cost originally paid for the return target merchandise item in the transaction. An exchange replaces the return target merchandise item with another merchandise item of the same kind or equivalent. For example, another merchandise item of the same kind is a merchandise item with the same merchandise code. In this context, a merchandise code is identification information that is allocated on a per merchandise item basis and that can uniquely identify the merchandise item by type. For example, the merchandise code is a JAN (Japanese Article Number) code but is not limited to this.

The merchandise return support system S includes a server 1, a user terminal 2, a store terminal 3, a brick-and-mortar store server 4, and an EC store server 5. The server 1, the user terminal 2, the store terminal 3, the brick-and-mortar store server 4, and the EC store server 5 are communicably connected to each other via a network NW. The network NW includes one or more of various networks such as the internet, a mobile communication network, and a LAN (local area network). The LAN may be a wireless LAN or a wired LAN. The merchandise return support system S includes at least one electronic device.

While one user terminal 2 is shown in FIG. 1, the merchandise return support system S may include a plurality of user terminals 2. While one store terminal 3 is shown in FIG. 1, the merchandise return support system S may include a plurality of store terminals 3. While one brick-and-mortar store server 4 is shown in FIG. 1, the merchandise return support system S may include a plurality of brick-and-mortar store servers 4. While one EC store server 5 is shown in FIG. 1, the merchandise return support system S may include a plurality of EC store servers 5.

The server 1 is an electronic device that supports an online merchandise return procedure. For example, the server 1 provides a merchandise return procedure as a cloud-based service. The server 1 is configured to support merchandise return procedures for merchandise items sold at a plurality of stores operated by a plurality of business operators. The server 1 may be operated an entirely different operator than any of the stores. The business operator of the server 1 can be an operator of one of the various stores selling a merchandise item or the like. For example, the business operator is a retailer. The meaning of the term “business operator” here includes not only a store operator but may include a store's overall business operating group. The business operating group is a group that operates multiple stores recognized as affiliated stores or under the same brand, franchise name, or the like. For example, the business operator's group is a group of franchise operators or the like that operate stores with the same name. The server 1 may be configured to support a merchandise return procedure for a merchandise item sold at multiple stores operated by the same business operator. The server 1 is an example of a merchandise return support device.

The user terminal 2 is an electronic device used by a user. The meaning of the term “user” includes a customer. The user terminal 2 is a tablet terminal, a smartphone, or a PC (personal computer) or the like, but is not limited to these.

The store terminal 3 is an electronic device used by store staff. In this example, the store terminal 3 is assumed to be a terminal used by staff of a store selling a return target merchandise item (an item to be returned). The store terminal 3 can be a tablet terminal, a smartphone, or a PC (personal computer) or the like, but is not limited to these. A member of the store staff can be an operator of the store terminal 3.

The brick-and-mortar store server 4 is an electronic device that manages (tracks) purchase data at a brick-and-mortar store. The purchase data is data managed on the store side that sells a merchandise item. The purchase data is data about a merchandise item for which a transaction was made. For example, the purchase data includes data such as a store code, a transaction code, a date and time of transaction, a merchandise code, a unit price, the number of items in the transaction, and an amount due (transaction total). The store code is identification information that can uniquely identify the store. The transaction code is identification information that can uniquely identify the transaction. The date and time of transaction is the date and time of the transaction. The merchandise code is identification information that can uniquely identify the merchandise item for which the transaction was made. The unit price is the price per merchandise item for which the transaction was made. The number of items is the number of merchandise items in the transaction. The amount due is the sum of the prices for the items in the transaction. The purchase data may include other information in addition to these items.

The brick-and-mortar store server 4 has an auxiliary memory device that stores the purchase data on a per transaction basis (that is, for each transaction separately). The auxiliary memory device can be one or more memory devices. The memory device is an EEPROM® (electrically erasable programmable read-only memory), an HDD (hard disk drive), an SSD (solid-state drive), or a flash memory or the like, but is not limited to these. The auxiliary memory device provided in the brick-and-mortar store server 4 is an example of a memory unit of the brick-and-mortar store server 4. The auxiliary memory device of the brick-and-mortar store server 4 may store merchandise master data. The auxiliary memory device of the brick-and-mortar store server 4 may store user data. The brick-and-mortar store server 4 is an example of a store server.

The EC store server 5 is an electronic device that manages (tracks) purchase data at an EC store. The EC store server 5 has an auxiliary memory device that stores the purchase data. The auxiliary memory device provided in the EC store server 5 is an example of a memory unit of the EC store server 5. The auxiliary memory device of the EC store server 5 may store merchandise master data. The auxiliary memory device of the EC store server 5 may store user data. The EC store server 5 is an example of the store server.

An example of the configuration of the server 1 will now be described.

FIG. 2 is a block diagram schematically showing the example of the configuration of the server 1.

The server 1 includes a processing circuit 10, a main memory 11, an auxiliary memory device 12, and a communication interface 13. The processing circuit 10, the main memory 11, the auxiliary memory device 12, and the communication interface 13 are connected in such a way as to be able to input and output a signal from and to each other. In FIG. 2, the interface is described as “I/F”.

The processing circuit 10 can be one or more circuits that execute a plurality of processes for performing a plurality f functions. The circuit(s) can be a processor, an ASIC (application-specific integrated circuit) or an FPGA (field-programmable gate array) but is not limited to these. For example, the processor can be a CPU (central processing unit) or a GPU (graphics processing unit) but is not limited to these. The processing circuit 10 executes a program stored in advance in the main memory 11 or the auxiliary memory device 12. The program is a software program or the like that can cause the processing circuit 10 to execute processing according to an embodiment. The processing circuit 10 executes the program loaded in the main memory 11 and thus can execute various processing.

The main memory 11 includes a non-volatile memory area and a volatile memory area. The main memory 11 stores an operating system or a program in the non-volatile memory area. The main memory 11 uses the volatile memory area as a work area where data is rewritten by the processing circuit 10 according to need. For example, the main memory 11 includes a ROM (read-only memory) as the non-volatile memory area. For example, the main memory 11 includes a RAM (random-access memory) as the volatile memory area.

The auxiliary memory device 12 stores a program and data used by the processing circuit 10 to execute various processing and the data generated by the processing circuit 10. A plurality of memory areas may be included in one auxiliary memory device 12 or may be distributed among a plurality of memory devices.

The auxiliary memory device 12 includes a purchase data memory area 121. The purchase data memory area 121 stores purchase data at each store. The processing circuit 10 acquires the purchase data from the brick-and-mortar store server 4 via the network NW. The processing circuit 10 saves the acquired purchase data in the purchase data memory area 121. Similarly, the processing circuit 10 acquires the purchase data from the EC store server 5 via the network NW. The processing circuit 10 saves the acquired purchase data in the purchase data memory area 121. The processing circuit 10 may periodically acquire the purchase data from the brick-and-mortar store server 4 or the EC store server 5. The processing circuit 10 may output a request including a specified transaction code to the brick-and-mortar store server 4 or the EC store server 5 and thus may acquire the purchase data including the specified transaction code. The purchase data memory area 121 is an example of a memory unit for storing the purchase data. The data stored in the purchase data memory area 121 is updated by an addition or deletion of purchase data, or the like.

The auxiliary memory device 12 includes a merchandise master memory area 122. The merchandise master memory area 122 stores merchandise master data for each store. The merchandise master data includes merchandise data about a merchandise item for sale at the store on a per merchandise item basis. The merchandise data includes data for items such as a merchandise code, a merchandise name, a unit price, and feature data associated with the merchandise item. The merchandise code is identification information that can uniquely identify the merchandise item. The merchandise name is the name of the merchandise item. The unit price is the price per merchandise item. The feature data associated with the merchandise item is data representing external features of the merchandise item. For example, the feature data of the merchandise item can be image data acquired for the merchandise item. The merchandise data may include additional data other than these types. The processing circuit 10 may periodically acquire the merchandise master data from the brick-and-mortar store server 4 or the EC store server 5. The processing circuit 10 saves the acquired merchandise master data in the merchandise master memory area 122. The merchandise master memory area 122 is an example of a memory unit for storing the merchandise master data. The data stored in the merchandise master memory area 122 is updated by an update of the merchandise master data.

The auxiliary memory device 12 includes a user data memory area 123. The user data memory area 123 stores user data of each user. The user data is data correlated with the user. The user data can include attribute information about the user. The attribute information about the user is information that characterizes the user in a general manner. For example, the attribute information about the user can be the age, gender, and residence of the user, but is not limited to these.

The user data can include a transaction record of the user on a per store basis or on a per business operator basis. The transaction record is a record indicating the extent to which the user makes transactions. The transaction record is data found based on the purchase data. For example, the transaction record includes all or a part of a transaction amount, a transaction frequency, and the latest date of transaction. The transaction record may include other information than these pieces of information. The transaction amount is an amount related to transactions. The transaction amount may be the total of the amounts of individual transactions or the average of the amounts of individual transactions. For example, the transaction amount can be found based on the amount included in the purchase data. The transaction frequency is a frequency related to transactions. The transaction frequency may be the number of transactions per predetermined number of days. The predetermined number of days can be suitably set. For example, the transaction frequency can be found based on the date and time of transaction included in the purchase data. The latest date of transaction refers to the day when the most recent transaction was made. For example, the latest date of transaction can be found based on the date and time of transaction included in the purchase data. The transaction record may be found based on the purchase data within a predetermined period or may be found based on the purchase data without being limited to any period. The length of the predetermined period can be suitably set. The transaction record may be data found by various analytical techniques such as RFM (recency, frequency, monetary) analysis or decile analysis.

The user data can include a merchandise return history on a per store basis or on a per business operator basis. The merchandise return history is a history of merchandise returns. For example, the merchandise return history includes the date of return and the merchandise name of the returned merchandise item or the like on a per merchandise return basis. The user data can include a complaint history on a per store basis or on a per business operator basis. The complaint history is a history of complaints made by the user. For example, the complaint history includes the date and time or the like on a per complaint basis.

The processing circuit 10 may periodically acquire the user data from the brick-and-mortar store server 4 or the EC store server 5. The processing circuit 10 saves the acquired user data in the user data memory area 123. The processing circuit 10 may not acquire the transaction record from the brick-and-mortar store server 4 or the EC store server 5. In this case, the processing circuit 10 may find the transaction record, based on the data stored in the purchase data memory area 121. The user data memory area 123 is an example of a memory unit for storing the user data. The data stored in the user data memory area 123 is updated by an update of the user data.

The communication interface 13 includes various interfaces that connect the server 1 communicably with another electronic device via the network NW in conformity with a predetermined communication protocol. The communication interface 13 is an example of a communication unit of the server 1.

The hardware configuration of the server 1 is not limited to the foregoing configuration. In the server 1, any one of the foregoing elements can be omitted or substituted and additional elements can be added according to need.

Each of the various units implemented by the processing circuit 10 will now be described.

The processing circuit 10 implements an acquisition unit 101, a determination processing unit 102, and an output unit 103. Each unit implemented by the processing circuit 10 can also be referred to as each function. It can also be said that each unit implemented by the processing circuit 10 is implemented by a control unit including the processing circuit 10 and the main memory 11.

The acquisition unit 101 acquires data, information, or an instruction or the like from another electronic device via the network NW. The meaning of “acquiring” here includes receiving.

The determination processing unit 102 determines a response for a return target merchandise item. For example, the determination processing unit 102 determines a response for a return target merchandise item corresponding to the state of the return target merchandise item. The meaning of “determining a response for a return target merchandise item” here includes deciding a response for a return target merchandise item.

In this context, the state of the return target merchandise item is the state of the merchandise item as of when the user begins the process to return the merchandise item. For example, the relevant state of the return target merchandise item is the external state or appearance of the merchandise item. For example, the item may be in a still unopened package, an opened package, or without original packaging or the like. For example, the packaging may be a box, a bag or the like. The item may have packaging provided by its manufacturer or may have been packaged at the store by store staff or the like. Returns may be conditional on the item being in its original packaging or opened packages may also be permitted for returns depending on the product or item. The evaluation of the external state of the return target merchandise item may relate to the state of wear on the item. The state of wear is generally displayed on an externally visible part of the return target merchandise item. For example, a wear state may include a degradation such as a damage or a stain on the item.

The response for the return target merchandise item is a response from the store or the business operator operating the store. The response may indicate that the return target merchandise item is returnable or the return target merchandise item is unreturnable.

A response that indicating return target the merchandise item is returnable may indicate that the return target merchandise item is returnable for a full refund or an exchange or that the return target merchandise item is returnable only for a partial refund. A full refund allows the return of the merchandise item with a return of the full amount of the cost paid for the return target merchandise item to the user. A return for exchange allows the replacement of the return target merchandise item with a merchandise item of the same kind. A return for a partial refund allows the return of the merchandise item with the return just some of the cost paid for the return target merchandise item to the user.

A response indicating that the return target merchandise item is unreturnable may indicate that the return target merchandise item is simply unreturnable or that the return target merchandise item is unreturnable but with a promotion to be provided to the user. In this context, a promotion is the provision of a gift or benefit to the user from the store or by the business operator operating the store. In general, the gift/benefit is provided for the purpose of motivating the user to continue using the store or another store operated by the business operator operating this store. For example, the gift may be a monetary value equivalent less than the transaction amount for the return target merchandise item. The gift may be a tangible article such as a token gift or may be a voucher. The voucher may be a voucher that can be used just at the store selling the return target merchandise item or may be a voucher that can be used at another store. The voucher may be a discount voucher or an exchange ticket for a merchandise item. The provision of the gift includes sending or physically providing the actual gift to the user. The provision of the gift includes providing a digital voucher that can be displayed at the user terminal 2.

The response indicating that the return target merchandise item is unreturnable without a promotion is to not carry out the promotion to the user if the return of the return target merchandise item is not allowed. Not carrying out the promotion to the user includes not providing a gift to the user. The response indicating that the return target merchandise item is unreturnable with a promotion is to carry out the promotion to the user if the return of the return target merchandise item is not allowed. Carrying out the promotion to the user includes providing a gift to the user.

The output unit 103 outputs data or information or the like to another electronic device via the network NW. The meaning of “outputting” here includes transmitting.

An example of the configuration of the user terminal 2 will now be described.

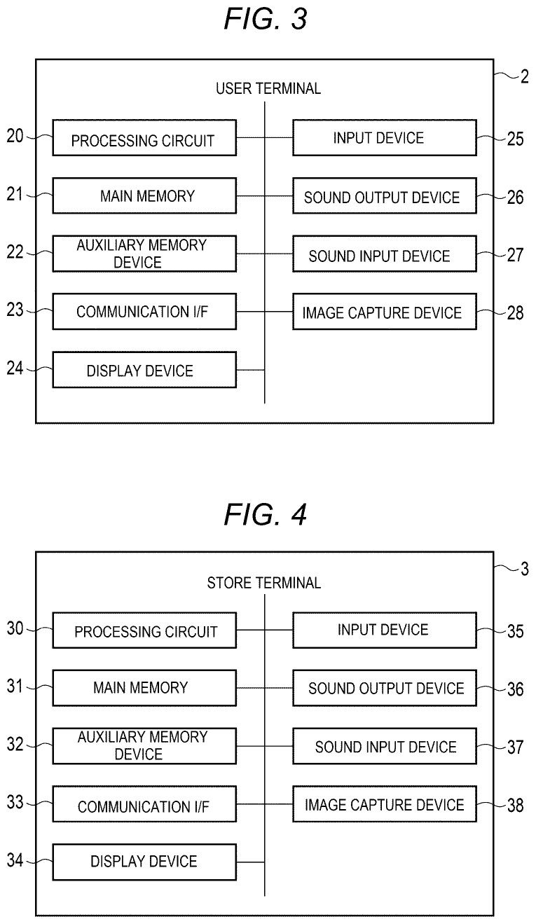

FIG. 3 is a block diagram schematically showing the example of the configuration of the user terminal 2.

The user terminal 2 includes a processing circuit 20, a main memory 21, an auxiliary memory device 22, a communication interface 23, a display device 24, an input device 25, a sound output device 26, a sound input device 27, and an image capture device 28. The processing circuit 20, the main memory 21, the auxiliary memory device 22, the communication interface 23, the display device 24, the input device 25, the sound output device 26, the sound input device 27, and the image capture device 28 are connected in such a way as to be able to input and output signals from and to each other. In FIG. 3, the interface is described as “I/F”.

The processing circuit 20 can be one or more circuits that execute a plurality of processes for implementing a plurality of functions. Examples of the processing circuit are as described above.

The configuration of the main memory 21 may be similar to the configuration of the main memory 11.

The auxiliary memory device 22 stores a program and data used by the processing circuit 20 to provide various processing as well as data generated by the processing circuit 20.

The communication interface 23 includes various interfaces that connect the user terminal 2 communicably with another electronic device via the network NW in conformity with a predetermined communication protocol. The communication interface 23 is an example of a communication unit of the user terminal 2.

The display device 24 is a device that can display various images under the control of the processing circuit 20. For example, the display device 24 is a liquid crystal display or EL (electroluminescence) display or the like. The display device 24 is an example of a display unit of the user terminal 2.

The input device 25 is a device that can input an instruction or information or the like to the user terminal 2. The input device 25 may include a keyboard. The input device 25, together with the display device 24, may form a touch screen. The input device 25 is an example of an input unit of the user terminal 2.

The sound output device 26 is a device that can output a sound based on sound data. For example, the sound output device 26 is a speaker.

The sound input device 27 is a device that can input sound data based on a sound. For example, the sound input device 27 is a microphone. The sound input device 27 is an example of the input unit of the user terminal 2.

The image capture device 28 is a device that can capture an image under the control of the processing circuit 20. For example, the image capture device 28 is a camera. The image capture device 28 is an example of an image capture unit of the user terminal 2.

The hardware configuration of the user terminal 2 is not limited to the foregoing configuration. In the user terminal 2, any one of the foregoing elements can be omitted or substituted and additional elements can be added according to need.

An example of the configuration of the store terminal 3 will now be described.

FIG. 4 is a block diagram schematically showing the example of the configuration of the store terminal 3.

The store terminal 3 includes a processing circuit 30, a main memory 31, an auxiliary memory device 32, a communication interface 33, a display device 34, an input device 35, a sound output device 36, a sound input device 37, and an image capture device 38. The processing circuit 30, the main memory 31, the auxiliary memory device 32, the communication interface 33, the display device 34, the input device 35, the sound output device 36, the sound input device 37, and the image capture device 38 are connected in such a way as to be able to input and output a signal from and to each other. In FIG. 4, the interface is described as “I/F”.

The processing circuit 30 is an element forming a computer corresponding to the store terminal 3. The processing circuit 30 can be one or more circuits that execute a plurality of processes for implementing a plurality of functions. Examples of a processing circuit are as described above. The processing circuit 30 executes a program stored in advance in the main memory 31 or the auxiliary memory device 32.

The configuration of the main memory 31 may be similar to the configuration of the main memory 11.

The auxiliary memory device 32 stores a program and data used by the processing circuit 30 to execute various processing and data generated by the processing of the processing circuit 30.

The communication interface 33 may comprise various interfaces that connect the store terminal 3 communicably via another electronic device via the network NW in conformity with a predetermined communication protocol. The communication interface 33 is an example of a communication unit of the store terminal 3.

The display device 34 is a device that can display various images under the control of the processing circuit 30. The configuration of the display device 34 may be similar to the configuration of the display device 24. The display device 34 is an example of a display unit of the store terminal 3.

The input device 35 is a device that can receive a user input and send an instruction or information or the like corresponding thereto to the store terminal 3. The input device 35 may include a keyboard. The input device 35, together with the display device 34, may form a touch screen. The input device 35 is an example of an input unit of the store terminal 3.

The sound output device 36 is a device that can output a sound based on sound data. For example, the sound output device 36 is a speaker.

The sound input device 37 is a device that can receive sounds and output sound data based on a sound. For example, the sound input device 37 is a microphone. The sound input device 37 is one example of an input unit of the store terminal 3.

The image capture device 38 is a device that can capture an image under the control of the processing circuit 30. For example, the image capture device 38 is a camera. The image capture device 38 is an example of an image capture unit of the store terminal 3.

The hardware configuration of the store terminal 3 is not limited to the foregoing configuration. In the store terminal 3, any of the foregoing elements can be omitted or substituted and additional elements can be added according to need.

### Example of Operation

Processing in the merchandise return support system S will now be described.

The processing procedures described below are simply an example. Each process may be changed as far as possible. In the processing procedures described below, a process can be omitted, replaced, and added according to the need of the embodiment.

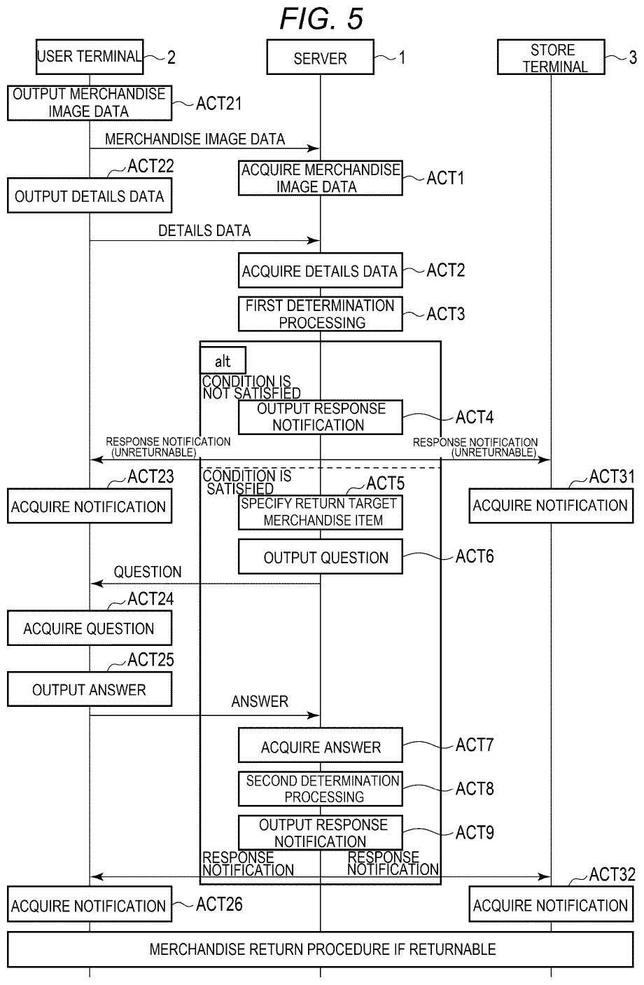

FIG. 5 is a sequence chart illustrating the processing in the merchandise return support system S.

In the description below, the user who carries out a merchandise return procedure for a return target merchandise item is referred to as a target user. The store that sold the return target merchandise item is referred to as a target store. The business operator operating the store that sold the return target merchandise item is referred to as a target business operator.

The target user operates the user terminal 2 and thus may access a web page for the merchandise return procedure or may start an application.

The processing circuit 20 of the user terminal 2 outputs merchandise image data (ACT 21). The merchandise image data is image data of the return target merchandise item of the target user. The merchandise image data may be video image data or image data of one or more still images. In ACT 21, for example, the processing circuit 20 outputs the merchandise image data to the server 1 via the network NW, based on the image capture of the return target merchandise item by the image capture device 28. The target user uploads the merchandise image data to the server 1, using the user terminal 2, and thus can carry out the merchandise return procedure without visiting the target store.

The processing circuit 10 of the server 1 acquires the merchandise image data (ACT 1). ACT 1 may be processing by the acquisition unit 101 implemented by the processing circuit 10. In ACT 1, for example, the processing circuit 10 acquires the merchandise image data from the user terminal 2 via the network NW. The server 1 can acquire the merchandise image data online and therefore can support the target user to carry out the merchandise return procedure without vising the target store.

The processing circuit 20 of the user terminal 2 outputs details data (ACT 22). The details data provides the details of the transaction (original transaction) originally including the return target merchandise item. The details can be provided in the form of a receipt or a payment receipt or the like. For example, the details may include information about the store where the transaction was made, the date and time of transaction, transaction information, merchandise information, and information about the total amount of the transaction. The details may include other information than these pieces of information. For example, the information about the store where the transaction was made includes the name of the store and the store code. The information about the store where the transaction was made may also include other information. For example, the transaction information includes the transaction code. The transaction information may also include other information. For example, the merchandise information includes the merchandise code, the merchandise name, the unit price, the number of items, and the amount for each item of merchandise in the transaction. The merchandise information may also include other information. The information about the total amount of the transaction includes the total amount of the transaction. The total amount of the transaction is an amount found by totaling the amounts due for the individual merchandise items in the same transaction.

In an example, details data can be data acquired from an image of the transaction receipt or the like captured by the image capture device 28. In this example, the processing circuit 20 outputs the details data to the server 1 via the network NW based on an image captured by the image capture device 28 of a paper receipt. In another example, the details data can be electronically provided. In this example, the processing circuit 20 outputs the details data to the server 1 via the network NW based on an instruction by the target user input via the input device 25 to output the details data. For example, the target user uploads the details data to the server 1 using the user terminal 2, and thus can carry out the merchandise return procedure without visiting the target store.

The processing circuit 10 of the server 1 acquires the details data (ACT 2). The processing associated with ACT 2 may be processing by the acquisition unit 101 as implemented by the processing circuit 10. In ACT 2, for example, the processing circuit 10 acquires the details data from the user terminal 2 via the network NW. The server 1 can acquire the details data online and therefore can support the target user to carry out the merchandise return procedure without vising the target store.

The processing circuit 10 of the server 1 executes first determination processing (ACT 3). The processing associated with ACT 3 may be processing by the determination processing unit 102 as implemented by the processing circuit 10. The first determination processing the is processing of determining whether the transaction of the return target merchandise item represented by the details data satisfies a return condition or not. The return condition is that the purchase data about the transaction of the return target merchandise item represented by the details data exists. If the purchase data about the transaction of the return target merchandise item exists, the transaction of the return target merchandise item satisfies the return condition. If the purchase data does not exist, the transaction related to the return target merchandise item does not satisfy the return condition.

If the details data is data about a transaction at a store that supports the merchandise return procedure in the merchandise return support system S, the purchase data about the transaction of the return target merchandise item exists. However, if the details data is data about a transaction at a store other than the store that supports the merchandise return procedure in the merchandise return support system S, the purchase data about the transaction of the return target merchandise item can be considered no to exist. In this way, the first determination processing is the processing to determine whether the details data is appropriate or not. The server 1 prevents the return of the merchandise item using details data from an irrelevant store and thus can properly support the target user to carry out the online merchandise return procedure.

In ACT 3, for example, the processing circuit 10 determines whether the purchase data about the transaction of the return target merchandise item represented by the details data exists or not, based on the details data. If the purchase data including the transaction code included in the details data is stored in the purchase data memory area 121, the processing circuit 10 can determine that the purchase data exists. If the purchase data including the transaction code included in the details data is not stored in the purchase data memory area 121, the processing circuit 10 can determine that the purchase data does not exist.

In some cases, the target user intends to return the return target merchandise item immediately after the transaction. In such cases, the purchase data about the transaction of the return target merchandise item may not be stored in the purchase data memory area 121. If the purchase data including the transaction code included in the details data is not stored in the purchase data memory area 121, the processing circuit 10 may perform processing as follows. For example, the processing circuit 10 outputs a request including the transaction code included in the details data, to the store server of the target store specified by the store code included in the details data. The request including the transaction code included in the details data is a request to inquire about the purchase data including the transaction code included in the details data. If the purchase data including the transaction code included in the details data is stored in the store server, the processing circuit 10 acquires the purchase data including the transaction code included in the details data. In this case, the processing circuit 10 can determine that the purchase data about the transaction of the return target merchandise item exists. If the purchase data including the transaction code included in the details data is not stored in the store server, the processing circuit 10 does not acquire the purchase data including the transaction code included in the details data. In this case, the processing circuit 10 can determine that the purchase data about the transaction of the return target merchandise item does not exist.

If the transaction of the return target merchandise item represented by the details data does not satisfy the return condition (NO in ACT 3), the processing circuit 10 determines that the return target merchandise item is unreturnable, as a response for the return target merchandise item. For example, a response indicating that the return target merchandise item is unreturnable is a response indicating that the return target merchandise item is unreturnable without a promotion. The processing shifts from ACT 3 to ACT 4. By determining that the return target merchandise item is unreturnable, the server 1 can prevent the return of the merchandise item using details data from an irrelevant store and thus can properly support the target user to carry out the online merchandise return procedure.

The processing circuit 10 of the server 1 outputs a response notification (ACT 4). The processing associated with ACT 4 may be processing by the output unit 103 as implemented by the processing circuit 10. The response notification is a notification about the response for the return target merchandise item determined by the processing circuit 10. For example, the response notification is a notification to display a message showing the response for the return target merchandise item. In ACT 4, the response notification is about the response indicating that the return target merchandise item is unreturnable. In ACT 4, for example, the processing circuit 10 outputs the response notification indicating that the return target merchandise item is unreturnable to the user terminal 2 via the network NW. The server 1 outputs the response notification to the user terminal 2 and thus can support the target user in carrying out the merchandise return procedure without visiting the target store. The processing circuit 10 outputs the response notification indicating that the return target merchandise item is unreturnable to the store terminal 3 via the network NW. The server 1 outputs the response notification to the store terminal 3 and thus can help the staff at the target store to check the final response regarding the return of the target merchandise item without requiring staff to handle all the merchandise return processes for the target user.

The processing circuit 20 of the user terminal 2 acquires the response notification (ACT 23). In ACT 23, for example, the processing circuit 20 acquires the response notification indicating that the return target merchandise item is unreturnable from the server 1 via the network NW. The processing circuit 20 causes the display device 24 to display a message showing the response indicating the return target merchandise item is unreturnable. The target user can check this response without visiting the target store.

The processing circuit 30 of the store terminal 3 acquires the response notification (ACT 31). In ACT 31, for example, the processing circuit 30 acquires the response notification indicating that the return target merchandise item is unreturnable from the server 1 via the network NW. The processing circuit 30 causes the display device 34 to display a message showing that the return target merchandise item is unreturnable. The staff at the target store can check the final response regarding the return target merchandise item without handling with the merchandise return processes for the target user.

If the transaction including the return target merchandise item satisfies (as represented by the details data) the return condition (YES in ACT 3), the processing shifts from ACT 3 to ACT 5. In this case, the processing circuit 10 determines a response for the return target merchandise item based on the state of the return target merchandise item, as in ACT 8.

The processing circuit 10 of the server 1 specifies the return target merchandise item (ACT 5). The processing associated with ACT 5 may be processing by the determination processing unit 102 as implemented by the processing circuit 10. In ACT 5, for example, the processing circuit 10 specifies each merchandise item related to the original transaction based on the purchase data about the transaction of the return target merchandise item. In this example, the processing circuit 10 can specify a merchandise item of the purchase data including the transaction code included in the details data, as the merchandise item related to the transaction of the return target merchandise item. The processing circuit 10 may specify the merchandise name of each merchandise item related to the transaction of the return target merchandise item, referring to the merchandise master data. The processing circuit 10 specifies the return target merchandise item from among the merchandise items related to the transaction of the return target merchandise item, based on the image data of the return target merchandise item. In this example, the processing circuit 10 compares the image data of the return target merchandise item with the feature data of the merchandise item included in the merchandise master data and thus can specify the return target merchandise item. The server 1 can specify the return target merchandise item without generating communication with the target user.

The processing circuit 10 may specify the return target merchandise item by communication with the target user. In an example, the processing circuit 10 outputs information about merchandise items related to the transaction involving the return target merchandise item to the user terminal 2 via the network NW. For example, the information about the merchandise items is the merchandise names. The processing circuit 20 of the user terminal 2 acquires the information about the merchandise items related to the transaction involving the return target merchandise item from the server 1 via the network NW. The processing circuit 20 causes the display device 24 to display a list of the merchandise items related to the transaction. For example, the list of the merchandise items is a list with the merchandise names of the merchandise items. The target user can select the return target merchandise item from the listed merchandise items using the input device 25. The processing circuit 20 outputs the information about the merchandise item selected as the return target merchandise item to the server 1 via the network NW after the selection of the return target merchandise item by the user via the input device 25. The processing circuit 10 of the server 1 acquires the information about the merchandise item selected as the return target merchandise item from the user terminal 2 via the network NW. The processing circuit 10 specifies the return target merchandise item from among the merchandise items in the transaction based on the item selected as the return target merchandise item. The server 1 can securely specify the return target merchandise item by the communication with the target user.

In another example, the processing circuit 10 outputs a question (information request or question information) about the return target merchandise item to the user terminal 2 via the network NW. The processing circuit 10 may output the question information about the return target merchandise item to the user terminal 2 by use of a chatbot or the like. The processing circuit 20 of the user terminal 2 acquires the question information about the return target merchandise item from the server 1 via the network NW. The processing circuit 20 causes the display device 24 to display the question. The processing circuit 20 may output the question or request as sound from the sound output device 26. The target user can input information about the return target merchandise item as an answer to the question using the input device 25 or the sound input device 27. For example, the answer to the question may be the merchandise name of the return target merchandise item. The processing circuit 20 outputs the information about the return target merchandise item to the server 1 via the network NW based on the information input by the user. The processing circuit 10 of the server 1 acquires the information about the return target merchandise item from the user terminal 2 via the network NW. The processing circuit 10 the identifies return target merchandise item from among the other merchandise items in the transaction based on the information about the return target merchandise item. The server 1 can securely specify the return target merchandise item by the communication with the target user.

The processing circuit 10 of the server 1 outputs a question (an information request) about the state of the return target merchandise item (ACT 6). In this context, the processing associated with ACT 6 may be processing by the output unit 103 as implemented by the processing circuit 10. In ACT 6, for example, the processing circuit 10 outputs a question about the state of the return target merchandise item to the user terminal 2 via the network NW. In some examples, the question about the state of the return target merchandise item may be automatically selected or provided by a chatbot or the like. The question about the state of the return target merchandise item may be from the staff at the store as input via the input device 35 or the sound input device 37 of the store terminal 3. The question about the state of the return target merchandise item can include a question about whether the package of the return target merchandise item is unopened or not. For example, the question may be: “The package of the return target merchandise item is already opened?” The question about the state of the return target merchandise item may be or further include a question (information request) about wear and tear on the return target merchandise item such as, “Tell us how much stain or dirt the return target merchandise item has”.

The processing circuit 20 of the user terminal 2 acquires the question (information request) about the state of the return target merchandise item (ACT 24). In ACT 24, for example, the processing circuit 20 acquires the question from the server 1 via the network NW. The processing circuit 20 causes the display device 24 to display the question (information request). The processing circuit 20 may output the question or request as a sound from the sound output device 26. The target user can input an answer to the question using the input device 25 or the sound input device 27. If the question is an inquiry about whether the package of the return target merchandise item is unopened or not, the answer could be “Already opened” or the like. If the question is about the state of wear on the return target merchandise item, the answer could be “Some stain or dirt but not substantial” or the like.

The processing circuit 20 of the user terminal 2 outputs the information for the answer to the question about the state of the return target merchandise item (ACT 25). In ACT 25, the processing circuit 20 outputs the answer to the server 1 via the network NW based on the information input by the user.

The processing circuit 10 of the server 1 acquires the answer to the question (ACT 7). In this context, the processing associated with ACT 7 may be processing by the acquisition unit 101 as implemented by the processing circuit 10. In ACT 7, for example, the processing circuit 10 acquires the answer (the question answer) from the user terminal 2 via the network NW. The server 1 can collect the user answer(s) to the question(s) as information to enhance the accuracy in the determination for the response to the request to return the return target merchandise item.

If the processing circuit 10 does not use the answers to questions about the state of the return target merchandise item in a second determination processing the processing of ACT 5 and ACT 6 may be omitted.

In ACT 6, the processing circuit 10 of the server 1 may output a question (information request) to the user terminal 2 via the network NW about the reason for the return of the return target merchandise item. Such a question may be automatically set by a chatbot or the like or by the staff at the store via the input device 35 or the sound input device 37 of the store terminal 3. The question or request can include “Tell us the reason you want to return the merchandise item” or the like. The target user can provide an answer to the question or request using the input device 25 or the sound input device 27. For example, the answer may be “Different from what I expected” or the like. In ACT 7, the processing circuit 10 acquires the information about the answer from the user terminal 2 via the network NW. The staff on the store side can thus grasp (understand) the reason for the return.

In ACT 6, the processing circuit 10 of the server 1 may output information for a question to the user terminal 2 about desired content related to a promotion via the network NW. The content may include information regarding a possible gift or enticement for the customer. The gift content may describe the type of the possible gift such as a particular article (an item) or a voucher (e.g., a coupon or gift card). The question may be automatically set by a chatbot or the like or by the staff at the store via the input device 35 or the sound input device 37 of the store terminal 3. The question could be “Would you like a token gift or a voucher?” or the like. The target user answer the question using the input device 25 or the sound input device 27. For example, the answer may be “I would like a token gift” or the like. In ACT 7, the processing circuit 10 acquires the information about the answer from the user terminal 2 via the network NW. The server 1 can help provide the promotion as selected by the target user by referring to the information about the answer to the question.

Before ACT 8, the processing circuit 10 of the server 1 may output a request to the user terminal 2 via the network NW to capture a picture of the return target merchandise item again. If the already acquired in ACT 1 is inappropriate or unsuitable, the processing circuit 10 can output the request to the user terminal 2 for another picture or image. In this context, a picture or image is inappropriate when it is not suitable for the second determination processing. For example, the image may be too blurry or the like or only part of the return target merchandise item may be visible in the picture. The request may be automatically set by the server 1 based on the merchandise image data that was already acquired. The request may be input by the staff at the store via the input device 35 or the sound input device 37 of the store terminal 3. The request may be, for example, “Capture a zoom-up image in a bright place so that details of stain or dirt can be seen” or the like. The target user can then capture another image of the return target merchandise item using the image capture device 28 of the user terminal 2. The processing circuit 20 of the user terminal 2 outputs the merchandise image data to the server 1 via the network NW, as in ACT 21. The processing circuit 10 of the server 1 acquires the merchandise image data from the user terminal 2 via the network NW, as in ACT 1. The server 1 may then properly determine the state of the return target merchandise item by using an image suitable for the second determination processing. Thus, the server 1 can enhance the accuracy in the determination of the appropriate response for the return target merchandise item.

The processing circuit 10 of the server 1 executes the second determination processing (ACT 8). The processing associated with ACT 8 may be processing by the determination processing unit 102 as implemented by the processing circuit 10. In this context, the second determination processing is the processing for determining the appropriate response for the return target merchandise item corresponding to the state of the return target merchandise item. In ACT 8, for example, the processing circuit 10 determines the state of the return target merchandise item based on image data of the return target merchandise item. In some examples, the processing circuit 10 may determine the state of the return target merchandise item based on image data and the answers to questions about the state of the return target merchandise item. The processing circuit 10 can determine whether the package of the return target merchandise item is unopened or not as a state of the return target merchandise item. The processing circuit 10 can determine the extent wear on the return target merchandise item as a state of the return target merchandise item. The processing circuit 10 may decide a level of wear present on the return target merchandise item from among a plurality of different levels of wear and thus may determine the state of wear on the return target merchandise item as one of the different levels. For example, the levels of wear can be three levels (high, middle, and low), but are not limited to these. The levels of wear may be two levels or may be four or more levels. In this example, it is assumed that the wear becomes worse as the level of wear becomes higher. The processing circuit 10 determines the response for the return target merchandise item based on the state of the return target merchandise item. A particular example of the second determination processing will be described later.

The processing circuit 10 can determine the response for a request to return a return target merchandise item based on the state of the return target merchandise item. The state may be accessed based on image data of the return target merchandise item. The server 1 can determine the response for the return request based on the image data uploaded by the target user and therefore can simplify online merchandise return procedure.

The processing circuit n also or instead determine the response for a return target merchandise item based on image data of the return target merchandise item and answers to questions about the state of the return target merchandise item. The server 1 can enhance the accuracy in the determination by using an answer to a question about the state of the return target merchandise item from the user.

The processing circuit 10 of the server 1 outputs a response notification (ACT 9). The processing associated with ACT 9 may be processing by the output unit 103 as implemented by the processing circuit 10. In ACT 9, for example, the processing circuit 10 outputs the response notification to the user terminal 2 via the network NW. The server 1 outputs the response notification to the user terminal 2 and thus can permit the target user to carry out the merchandise return procedure without visiting the target store. The processing circuit 10 outputs the response notification to the store terminal 3 via the network NW. The server 1 outputs the response notification to the store terminal 3 and thus can permit the staff at the target store to check the final response for the return target merchandise item without otherwise handling the merchandise return from the target user.

The response notification output by the processing circuit 10 varies depending on the second determination processing.

If the processing circuit 10 determines that the return target merchandise item is returnable, the processing circuit 10 outputs a response notification to indicate that the return target merchandise item is returnable. If the processing circuit 10 determines that the return target merchandise item is returnable with a full refund or an exchange, the processing circuit 10 outputs a response notification to indicate that the return target merchandise item is returnable with a full refund or an exchange. If the processing circuit 10 determines that the return target merchandise item is returnable with a partial refund, the processing circuit 10 outputs a response notification to indicate that the return target merchandise item is returnable with a partial refund.

If the processing circuit 10 determines that the return target merchandise item is unreturnable, the processing circuit 10 outputs a response notification to indicate that the return target merchandise item is unreturnable. If the processing circuit 10 determines that the return target merchandise item is unreturnable without a promotion, the processing circuit 10 outputs a response notification to indicate that the return target merchandise item is unreturnable without a promotion. If the processing circuit 10 determines that the return target merchandise item is unreturnable even with a promotion, the processing circuit 10 outputs a response notification to indicate that the return target merchandise item is unreturnable even with a promotion.

The processing circuit 20 of the user terminal 2 acquires the response notification (ACT 26). In ACT 26, for example, the processing circuit 20 acquires the response notification from the server 1 via the network NW. The processing circuit 20 causes the display device 24 to display a message showing the response for the return target merchandise item, based on the response notification. The target user can check the response for the return target merchandise item without visiting the target store.

The processing circuit 30 of the store terminal 3 acquires the response notification (ACT 32). In ACT 32, for example, the processing circuit 30 acquires the response notification from the server 1 via the network NW. The processing circuit 30 causes the display device 34 to display a message showing the response for the return target merchandise item, based on the response notification. The staff at the target store can check the final response for the return target merchandise item without coping with the merchandise return from the target user.

If the response for the return target merchandise item indicates that the return target merchandise item is returnable, the target user carries out a transport procedure (e.g., takes to a store or return location) for the return target merchandise item to return the return target merchandise item.

An example of the second determination processing in ACT 8 will now be described.

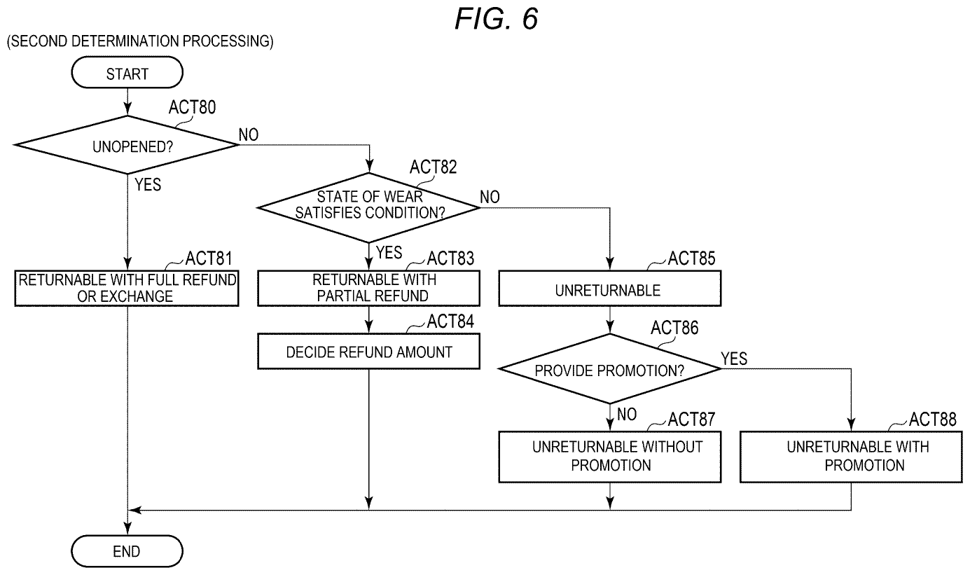

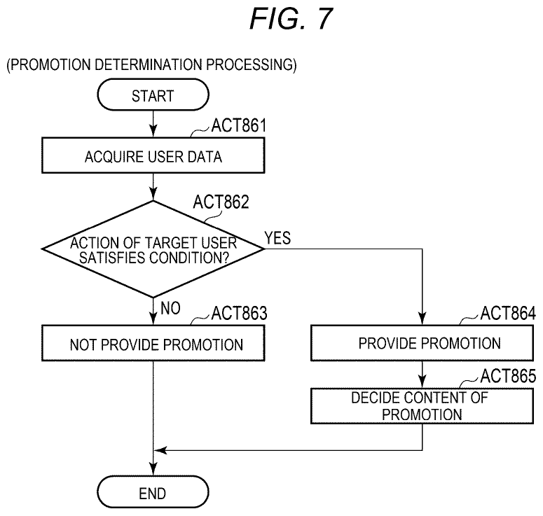

FIG. 6 is a flowchart showing an example of the second determination processing by the processing circuit 10 of the server 1.

The processing circuit 10 determines whether the package of the return target merchandise item is unopened or not (ACT 80). If the package of the return target merchandise item is unopened (YES in ACT 80), the processing shifts from ACT 80 to ACT 81. The processing circuit 10 determines that the return target merchandise item is returnable with a full refund or an exchange (ACT 81).

If the package of the return target merchandise item is not unopened (NO in ACT 80), the processing shifts from ACT 80 to ACT 82. The processing circuit 10 determines whether the state of wear of the return target merchandise item satisfies a wear condition or not (ACT 82). In this context, the wear condition concerns the state of wear of the return target merchandise item and is set to determine whether the return target merchandise item is returnable or unreturnable. For example, the wear condition is that the threshold reference level of wear on the return target merchandise item at which the item because returnable or unreturnable. The reference level of wear can be a level among a plurality of pre-established levels of wear. The reference level of wear can be suitably set according to business operator preference or the like. If the level of wear of the return target merchandise item is equal to or below the threshold reference level of wear, the state of wear of the return target merchandise item satisfies the wear condition. In this case, the degree of wear of the return target merchandise item is usually low. However, if the level of wear of the return target merchandise item is above the threshold reference level of wear, the state of wear of the return target merchandise item does not satisfy the wear condition. In this case, the degree of wear of the return target merchandise item is usually high.

The wear condition is not limited to conditions set using the levels as described above. The wear condition may be related to another specifiable state of the merchandise item. For example, used or unused may be the determining state of wear of the return target merchandise item. The specifiable state can be a state where the degree of wear is high or visible. In other examples, the specifiable state can be a state where there is a hole in the merchandise item, a state where there is a tear in the merchandise item, a state where there is a stain on the merchandise item, or the like, but is not limited to these. The specifiable state may be a state with a specified lower limit value on the size of the hole, the tear, or the stain or the like.

If the state of wear of the return target merchandise item satisfies the wear condition (YES in ACT 82), the processing shifts from ACT 82 to ACT 83. The processing circuit 10 determines that the return target merchandise item is returnable with a partial refund (ACT 83).

If the processing circuit 10 determines that the return target merchandise item is returnable with a partial refund, the processing circuit 10 may then decide the refund amount for the partial refund (ACT 84). The processing circuit 10 may decide an amount equivalent to some preset proportion of the cost original paid for the return target merchandise item, as the refund amount.

The processing circuit 10 may decide the refund amount for the partial refund based on the transaction record of the target user. In this example, the processing circuit 10 may decide on the refund amount in such a way that the refund amount for the partial refund becomes greater as the transaction amount included in the transaction record becomes greater. The processing circuit 10 may decide the refund amount in such a way that the refund amount for the partial refund becomes greater as the transaction frequency included in the transaction record becomes higher. The processing circuit 10 may decide the refund amount in such a way that the refund amount for the partial refund becomes greater as the latest date of transaction included in the transaction record becomes closer to the present time. The server 1 refers to the transaction record of the target user and thus can provide preferential treatment if the target user is a good customer of the store. By providing preferential treatment for the good customer, the server 1 can maintain a good relationship with the good customer and can increase the probability that the good customer continues using the target store.

The processing circuit 10 may decide the refund amount for the partial refund based on the merchandise return history of the target user. In this example, the processing circuit 10 may decide the refund amount in such a way that the refund amount for the partial refund becomes smaller as a merchandise return frequency becomes higher. The merchandise return frequency is the frequency of merchandise return by the user. The merchandise return frequency may be the number of merchandise returns during a predetermined number of prior days. The predetermined number of days can be suitably set by the business operator or the like. For example, the merchandise return frequency can be found, based on the date of return on a per merchandise return basis included in the merchandise return history. The merchandise return frequency may be found based on data within a predetermined period included in the merchandise return history or may be found based on data included in the merchandise return history without being limited to any period. The length of the predetermined period can be suitably set. The server 1 refers to the merchandise return history of the target user and thus can differentiate the refund amount between the case where the target user is a good customer of the target store and the case where the target user is not a good customer.

The processing circuit 10 may decide the refund amount for the partial refund based on the complaint history of the target user. In this example, the processing circuit 10 may decide the refund amount in such a way that the refund amount for the partial refund becomes smaller as a complaint frequency becomes higher. The complaint frequency may be the number of complaints over predetermined number of prior days. The predetermined number of days can be suitably set. For example, the complaint frequency can be found, based on the date of complaint on a per complaint basis included in the complaint history. The complaint frequency may be found based on data within a predetermined period included in the complaint history or may be found based on data included in the complaint history without being limited to any period. The length of the predetermined period can be suitably set. The server 1 refers to the complaint history of the target user and thus can differentiate the refund amount between the case where the target user is a good customer of the target store and the case where the target user is not a good customer.

If the state of wear of the return target merchandise item does not satisfy the wear condition (NO in ACT 82), the processing shifts from ACT 82 to ACT 85. The processing circuit 10 determines that the return target merchandise item is unreturnable, (ACT 85). If the processing circuit 10 determines that the return target merchandise item is unreturnable, the processing circuit 10 determines that the return target merchandise item is unreturnable without a promotion or that the return target merchandise item is unreturnable with a promotion, as in ACT 87 or ACT 88.

The processing circuit 10 determines whether provide a promotion to the target user or not (ACT 86).

If a promotion is not to be provided to the target user (NO in ACT 86), the processing shifts from ACT 86 to ACT 87. The processing circuit 10 determines that the return target merchandise item is unreturnable without a promotion (ACT 87).

If a promotion is to be provided to the target user (YES in ACT 86), the processing shifts from ACT 86 to ACT 88. The processing circuit 10 determines that the return target merchandise item is unreturnable even with a promotion (ACT 88).

An example of the promotion determination processing in ACT 86 will now be described.

FIG. 7 is a flowchart showing an example of the promotion determination processing by the processing circuit 10 of the server 1.

The processing circuit 10 acquires the user data of the target user from the user data memory area 123 (ACT 861).

The processing circuit 10 determines whether an action of the target user satisfies a promotion condition or not (ACT 862). Th action of the target user is a history of actions by the target user related to the transaction at the target store or at a store operated by the target business operator. For example, the action is a transaction, a merchandise return, and a complaint or the like, but is not limited to these.

In ACT 862, for example, the processing circuit 10 determines the action(s) of the target user based on the user data of the target user. The user data of the target user changes in accordance with various actions of the target user. The processing circuit 10 may identify a level of action of the target user from among a plurality of user levels and thus may determine the action(s) of the target user. The user levels here can be equivalent to good customer levels. In this example, it is assumed that the degree of being a good customer becomes higher as the user level becomes higher. A good customer is suitable as a target of a promotion. The level of the target user changes in accordance with the actions of the target user.

The promotion condition is a condition for determining whether to provide a promotion to the target user or not that may be based on the actions of the target user. For example, the promotion condition is that the level the target user is equal to or higher than some reference user level. The reference user level is a level selected from among the plurality of possible user levels. The reference user level can be suitably set by the store or the like. If the level of the target user is equal to or higher than the reference user level, the target user satisfies the promotion condition. In this case, the degree of the target user being a good customer is high. However, if the level of the action of the target user is not equal to or higher than the reference user level, the target user does not satisfy the promotion condition. In this case, the degree of the target user being a good customer is low.

The processing circuit 10 may decide the level of the target user based on the transaction record of the target user included in the user data of the target user. In this example, the processing circuit 10 may raise the level of the target user as the transaction amount in the transaction record becomes greater. The processing circuit 10 may raise the level of the target user as the transaction frequency in the transaction record becomes higher. The processing circuit 10 may raise the level of the target user as of the latest date of transaction (most recent) included in the transaction record becomes closer to the present time.

The processing circuit 10 may decide the level of the target user based on the merchandise return history of the target user included in the user data of the target user. In this example, the processing circuit 10 may lower the level of the target user as the merchandise return frequency becomes higher.

The processing circuit 10 may decide the level of the target user based on the complaint history of the target user included in the user data of the target user. In this example, the processing circuit 10 may lower the level of the target user as the complaint frequency becomes higher.

The promotion conditions are not limited to conditions using the levels as described above. A promotion condition may be that a particular action of the target user corresponds to a specified action in the promotion condition. However, if the action of the target user is not the specified action, the target user does not satisfy the promotion condition. In this context, the specified action of a promotion condition may be an action with a high degree of certainty for indicating a good customer. For example, the specified action may be related to a transaction, merchandise returns, or complaints, but is not limited to these. For example, if the customer has engaged in a transaction with a transaction amount above a certain amount, the customer may be likely to be a good customer. If the recent transaction frequency is above a certain number, if the customer is a long time customer or a first time customer, the customer may be treated as a good customer. If the customer rarely returns items or formally complains, the customer may be considered a good customer.

If the action of the target user does not satisfy the promotion condition (NO in ACT 862), the processing shifts from ACT 862 to ACT 863. The processing circuit 10 determines that a promotion is not to be provided (ACT 863). In this case, the processing circuit 10 determines that the return target merchandise item is unreturnable without a promotion, as in ACT 87.

If the action of the target user satisfies the promotion condition (YES in ACT 862), the processing shifts from ACT 862 to ACT 864. The processing circuit 10 determines that a promotion is to be provided (ACT 864). In this case, the processing circuit 10 determines that the return target merchandise item is unreturnable but with a promotion, as in ACT 88.

If the processing circuit 10 determines as in ACT 864, the processing circuit 10 decides the content of the promotion (ACT 865).

The processing circuit 10 may then decide the content of the promotion based on the level of the target user. In this example, the processing circuit 10 may select a promotion content (promotion level) at a monetary value based on the level of the target user. The server 1 refers to the level of the target user and thus can decide the content of the promotion that meets a set preferential treatment level for the target user when the target user is a good customer of the target store.

The processing circuit 10 may decide the content of the promotion based on the attribute information of the target user. In this example, the processing circuit 10 may decide a content corresponding to the attribute of the target user, as the content of the promotion. The server 1 refers to the attribute information of the target user and thus can select a promotion that may be more likely to be of particular interest to the target user.

The processing circuit 10 may select the promotion based on an answer to a question about a preferred content or type of a promotion. The processing circuit 10 may then select promotion content corresponding to the answer of the target user. The server 1 refers to the answer and thus can decide the content of the promotion that may be of interest to the target user.

As described above, the processing circuit 10 can determine the previous actions of the target user based on the user data of the target user. Therefore, the processing circuit 10 can determine that the return target merchandise item is unreturnable without a promotion or with a promotion based on the user data of the target user. The server 1 refers to the user data of the target user and thus can support provision of the promotion to the target user if the target user is a good customer of the target store.

As described above, the processing circuit 10 can determine that the return target merchandise item is unreturnable without a promotion or with a promotion, based on the actions (history) of the target user. The server 1 refers to the actions of the target user and thus can support provision of the promotion to the target user if the target user is a good customer who takes actions preferable to the target store.

As described above, the processing circuit 10 can determine that the return target merchandise item is simply unreturnable (without a promotion) or unreturnable but with a promotion, based on the transaction record of the target user included in the user data of the target user. The server 1 refers to the transaction record of the target user and thus can support provision of the promotion to the target user if the target user is a good customer having a transaction record preferable to the target store.

As described above, the processing circuit 10 can determine that the return target merchandise item is unreturnable or that the return target merchandise item is unreturnable but with a promotion, based on the merchandise return history of the target user included in the user data of the target user. The server 1 refers to the merchandise return history of the target user and thus can differentiate the need for provision of a promotion in terms of previous merchandise returns by the customer.

As described above, the processing circuit 10 can determine to provide a promotion or not based on the complaint history of the target user included in the user data of the target user. The server 1 refers to the complaint history of the target user thus can differentiate the need for a promotion accordingly.

### Modification Example

In ACT 8, the processing circuit 10 automatically determines a response for the return target merchandise item according to the state of the return target merchandise item established based on the image data of the return target merchandise item. However, this is not limiting. The processing circuit 10 may determine the response for a return target merchandise item based on the state of the return target merchandise item as designated by store staff upon review of the image data of the return target merchandise item. In this example, the processing circuit 10 of the server 1 outputs the image data of the return target merchandise item to the store terminal 3 via the network NW. When the processing circuit 10 acquires an answer to a question about the state of the return target merchandise item from the user terminal 2, the processing circuit 10 outputs the information of the answer to the store terminal 3.

The processing circuit 30 of the store terminal 3 acquires the image data of the return target merchandise item from the server 1 via the network NW. The processing circuit 30 acquires the information of the answer from the server 1 via the network NW. The processing circuit 30 causes the display device 34 to display an image based on the image data for the return target merchandise item. The processing circuit 30 causes the display device 34 also to display the answer to the question about the state of the return target merchandise item. The store staff may then examine the return target merchandise item while referring to the display on the display device 34. The store staff can designate a response for the return target merchandise item corresponding to the apparent state of the return target merchandise item using the input device 35. The processing circuit 30 outputs the designated response to the server 1 via the network NW based on the designation made the store staff via the input device 35.

The processing circuit 10 of the server 1 acquires the designated response from the store terminal 3 via the network NW. The processing circuit 10 then determines the response for the return target merchandise item based on the designated response.

The processing circuit 10 of the server 1 may output reference information that may be useful for a designation of a response by the store staff to the store terminal 3. For example, the reference information may be the customer's transaction record, merchandise return frequency, complaint frequency, attribute information, and answer to the question about desired content of a promotion or the like, but is not limited to these. The processing circuit 30 of the store terminal 3 acquires the reference information from the server 1 via the network NW. The processing circuit 30 causes the display device 34 to display an image based on the reference information.

According to an embodiment, the server 1 can determine the response for a return target merchandise item corresponding to the state of the return target merchandise item as established based on image data of the return target merchandise item.

Thus, the server 1 can support the online merchandise return procedure without a need for the target user to visit the target store. The server 1 can support the online merchandise return procedure with less involvement of the staff at the target store. In this way, the server 1 can support the simplified online merchandise return procedure.

### OTHER EMBODIMENTS

Some or all of the memory areas described as provided in the server 1 may be provided in an electronic device that other than the server 1. Some or all of the memory areas described as provided in the server 1 may be distributed among multiple electronic devices other than the server 1.

The server 1 may be implemented as one electronic device or a plurality of electronic devices with distributed functions.

The foregoing embodiments may be applied to a method executed by a system. The foregoing embodiments may be applied to a program that can cause a computer of the system to execute each of the described functions. The foregoing embodiments may be applied to a non-transient, computer-readable recording medium that stores the program.

A processing circuit may comprise a plurality of processors working in parallel or in series. The described processing and/or functions may be distributed among a plurality of processors or processing circuits working in conjunction or separately.

A program according to an embodiment may be stored in an electronic device according to the embodiment or may be provided separately from the electronic device according to the embodiment. In the latter case, the program may be provided via a network or in a recording medium. The recording medium can be a non-transient tangible medium that is a computer-readable medium. In general, the recording medium may be any medium that can store the program and be read by a computer, such as a CD-ROM or a memory card, and is not limited to any particular form or format.

While some embodiments of the present disclosure have been described, these embodiments are presented simply as examples and are not intended to limit the scope of the present disclosure. These novel embodiments can be implemented in various other forms and can include various omissions, replacements, and changes without departing from the spirit and scope of the present disclosure. These embodiments and modifications thereof are included in the spirit and scope of the present disclosure and also included in the scope of the claims and equivalents thereof.

What is claimed is:

1. A merchandise return support system, comprising:
a return support server configured to:
acquire image data for a merchandise item that a user is attempting to return;
identify a state of the merchandise item based on the image data;
determine a response regarding the attempt to return the merchandise item based on the identified state of the merchandise item; and
output a notification to a terminal of the user indicating the response regarding the attempt to return the merchandise item.

2. The merchandise return support system according to claim 1, wherein the return support server determines the response by selecting one of a response indicating the merchandise item is not returnable, a response indicating that the merchandise item is returnable, and a response indicating that the merchandise item is not returnable but a promotion is available to the user.

3. The merchandise return support system according to claim 2, wherein the response indicating that the merchandise item is returnable further indicates whether the merchandise item can be returned for a full refund, an exchange, or a partial refund.

4. The merchandise return support system according to claim 2, wherein return support server selects between the response indicating the merchandise item is not returnable and the response indicating that the merchandise item is not returnable but a promotion is available to the user based on a transaction history of the user.

5. The merchandise return support system according to claim 1, wherein
the return support server further acquires a user estimation of the state of the merchandise item and from the terminal of the user, and
the response regarding the attempt to return the merchandise item is further based on the user estimation of the state of the merchandise item.

6. The merchandise return support system according to claim 1, wherein
the return support server attempts to acquire details about a transaction in which the merchandise item was purchased, and
determines that the merchandise item is unreturnable if details about the transaction can not be acquired.

7. The merchandise return support system according to claim 6, wherein the return support server includes a storage device and attempts to acquire details about the transaction from the storage device.

8. The merchandise return support system according to claim 1, further comprising:
a store terminal, wherein
the return support server further outputs the notification to the store terminal.

9. A merchandise return support server, comprising:
a communication interface connectable to a user terminal via a network;
a storage device; and
a processor configured to:
acquire image data from the user terminal for a merchandise item that a user is attempting to return;
identify a state of the merchandise item based on the image data;
determine a response regarding the attempt to return the merchandise item based on the identified state of the merchandise item; and
output a notification to the user terminal indicating the response regarding the attempt to return the merchandise item.

10. The merchandise return support server according to claim 9, wherein the processor determines the response by selecting one of a response indicating the merchandise item is not returnable, a response indicating that the merchandise item is returnable, and a response indicating that the merchandise item is not returnable but a promotion is available to the user.

11. The merchandise return support server according to claim 10, wherein the response indicating that the merchandise item is returnable further indicates whether the merchandise item can be returned for a full refund, an exchange, or a partial refund.

12. The merchandise return support server according to claim 10, wherein the processors selects between the response indicating the merchandise item is not returnable and the response indicating that the merchandise item is not returnable but a promotion is available to the user based on a transaction history of the user stored in the storage device.

13. The merchandise return support server according to claim 9, wherein
the processor further acquires a user estimation of the state of the merchandise item and from the user terminal, and
the response regarding the attempt to return the merchandise item is further based on the user estimation of the state of the merchandise item.

14. The merchandise return support server according to claim 9, wherein
the processor attempts to acquire details about a transaction in which the merchandise item was purchased from the storage device, and
determines that the merchandise item is unreturnable if details about the transaction can not be acquired from the storage device.

15. The merchandise return support server according to claim 9, wherein the processor is further configured to output the notification to a store terminal via the network.

16. A merchandise return support method, comprising:
acquiring, at a return support server, image data for a merchandise item that a user is attempting to return;
identifying, at the return support server, a state of the merchandise item based on the image data;
determining, at the return support server, a response regarding the attempt to return the merchandise item based on the identified state of the merchandise item; and
outputting, from the return support server, a notification to a terminal of the user indicating the response regarding the attempt to return the merchandise item.

17. The merchandise return support method according to claim 16, further comprising:
outputting the notification to a store terminal.

18. The merchandise return support method according to claim 16, wherein the return support server determines the response by selecting one of a response indicating the merchandise item is not returnable, a response indicating that the merchandise item is returnable, and a response indicating that the merchandise item is not returnable but a promotion is available to the user.

19. The merchandise return support method according to claim 18, wherein the response indicating that the merchandise item is returnable further indicates whether the merchandise item can be returned for a full refund, an exchange, or a partial refund.

20. The merchandise return support method according to claim 18, wherein return support server selects between the response indicating the merchandise item is not returnable and the response indicating that the merchandise item is not returnable but a promotion is available to the user based on a transaction history of the user.
